(19) United States
(12) Patent Application Publication
(10) Pub. No.: US 2007/0072480 A1
(43) Pub. Date: Mar. 29, 2007

(54) RIBBON CABLE PLUG-IN CONNECTOR

(75) Inventor: Juergen Lappohn, Gammelshausen (DE)

Correspondence Address: DARBY & DARBY P.C., P. O. BOX 5257, NEW YORK, NY, 10150-5257, US

(73) Assignee: ERNI Elektroapparate GmbH, Adelberg (DE)

(21) Appl. No.: 11/465,318

(22) Filed: Aug. 17, 2006

(30) Foreign Application Priority Data
Aug. 19, 2005 (DE) 102005039620.8-34

(51) Int. Cl. H01R 11/20

(52) U.S. Cl. 439/405

(57) ABSTRACT

The invention proposes a ribbon cable plug-in connector (10) for connecting electronic components. The ribbon cable plug-in connector (10) comprises a plurality of plug-in contacts (14a, 14b) arranged in a plug-in connector element (11). A contact element (12a, 12b) arranged on the plug-in connector element (11), in the longitudinal direction (13) of the plug-in contacts (14a, 14b) is provided for full-surface contact-making with an electrically conductive ribbon cable screening (17, 17a, 17b) which encloses the ribbon cable (16) on its outside. For fixing the ribbon cable screening (17, 17a, 17b) on the contact element (12a, 12b) there is preferably provided at least one clamping element (15a, 15b). The ribbon cable plug-in connector (10) according to the invention allows contact between the ribbon cable screening (17, 17a, 17b) and the ribbon cable plug-in connector (10) to be easily established and ensures a high screening level.

### PRIOR ART

The present invention relates to a ribbon cable plug-in connector for connecting electronic components according to the preamble of the independent claim. DE 101 19 695 A1 describes a plug-in connector of the kind described in the preamble, where each of the two connector elements is provided with screening plates. In the plugged condition of the two connector elements, the screening plates are in substantially full-surface contact one with the other. The plug-in connector comprises a plurality of plug-in contacts, arranged in the form of two banks, which are configured as pin contacts and slot contacts.

A possibility to make contact with a ribbon cable screening, if any, of a ribbon cable connected with a plug-in connection element is not provided. In practice, such a connection is established, for example, by the steps of lifting the screening, which encloses the ribbon cable, partially off the ribbon cable, twisting it at a predetermined point, for example, and then soldering it to a contact arranged on a printed wiring board external to the plug-in connector. If the plug-in connector is to be detached later, this is possible only by either separating or unsoldering the ribbon cable screening.

For making contact with the outer conductor, which coaxially encloses the inner conductor, sockets or plugs of coaxial cables known in radio frequency technology comprise a tubular contact element, by means of which full-surface contact is established with the outer conductor, the latter having first been lifted off the insulation of the inner conductor. Fixing of the outer conductor on the contact element is effected by screwing down the outer connector shell. The outer conductor performs not only the function of a return line, but also the function of a screening. In addition to ensuring a predetermined screening level, the structure of the coaxial cable also guarantees a predefined surge impedance.

From the relevant basic literature, for example a textbook entitled “Taschenbuch der Hochfrequenz-Technik”, Meinke H. and Gundlach F. W., Springer-Verlag 1956, pp. 6-11, approximation formulas have been known for determining the inductance of conductor arrangements having different geometric configurations. Accordingly, a conductor arrangement having a rectangular cross-section, for example, has a lower inductance than a conductor that has a circular cross-section.

In computer technology, ribbon cable plug-in connectors for connecting drive controllers to the corresponding drives are known that used to comprise 40 lines, for example. As the data transfer rate increased, a need for a screening arose which need is satisfied today by ribbon cables which now comprise 80 lines, for example, with a signal line and a screening line associated to the signal line provided in alternate arrangement. All lines, including the screening lines, are contacted individually in the plug-in connection element, for example using insulation-piercing contact devices.

Now, it is the object of the present invention to provide a ribbon cable plug-in connector that allows contact to a ribbon cable screening to be made in a simple way.

That object is achieved by the features defined in the independent Claim.

### ADVANTAGES OF THE INVENTION

The ribbon cable plug-in connector according to the invention for connecting electronic components comprises a plurality of plug-in contacts arranged in a plug-in connector element. A contact element arranged on the plug-in connector element, in the longitudinal direction of the contacts, is provided for full-surface contact-making with an electrically conductive ribbon cable screening that encloses the ribbon cable on its outside.

The ribbon cable plug-in connector according to the invention allows especially easy contact-making between the ribbon cable screening and the ribbon cable plug-in connector. A substantial advantage further lies in the fact that the ribbon cable plug-in connector provides a high screening level because on the one hand the ribbon cable screening encloses the ribbon cable almost up to the ribbon cable plug-in connector according to the invention, while on the other hand the contact element takes over the screening function for that portion of the ribbon cable where the ribbon cable screening has been removed from the ribbon cable. Due to the structure of both the contact elements and the ribbon cable screening low inductance is achieved for the entire arrangement, which permits the arrangement to be linked to a circuit ground that remains in the low impedance range even at higher frequencies.

Advantageous further developments and configurations of the ribbon cable plug-in connector according to the invention will be apparent from the dependent claims.

According to one embodiment, the contact element is arranged at least on both sides of a ribbon cable bushing provided in a plug-in connector element for contacting the portion of the ribbon cable screening on the upper surface of the ribbon cable or the lower surface of the ribbon cable, respectively. With the aid of that feature, contact is made between almost the entire ribbon cable screening and the contact element.

One embodiment provides that the contact element is arranged adjacent to a ribbon cable bushing provided in the plug-in connector element. It is ensured in this way that the screening function is taken over, in the area of the ribbon cable bushing, directly by the contact element.

According to an especially advantageous embodiment, at least one clamping element is provided for fixing the ribbon cable screening. The clamping element presses the ribbon cable screening against the contact element so that reliable contact is guaranteed. Further, the strain loading capacity of the ribbon cable plug-in connector contacted by the ribbon cable is increased. An especially advantageous configuration is one where the contact element contains the at least one clamping element.

According to a further development of that embodiment, the at least one clamping element is given a resilient configuration. During assembly of the ribbon cable plug-in connector, the ribbon cable screening can be pushed into its position below the clamping element. Another, especially convenient further development of that embodiment provides that the at least one clamping element is deformable so that once contact has been established between the ribbon cable screening and the contact element, the clamping element can be pressed against the ribbon cable screening by an external force, applied for example by a punch.

According to one embodiment, the contact element comprises at least one recess, and the ribbon cable screening is pressed into the latter, and is keyed therein, by the clamping element. The recess contributes especially toward increasing the mechanical stability of the contact between the ribbon cable screening and the contact element. The fact that the ribbon cable screening is pressed into the recess at least in part, and is keyed therein, provides especially efficient fixing.

Another embodiment relates to the contact element which advantageously is produced by punching. The clamping element may likewise be produced by a single punching or cutting operation, in which case the punched-out or cut-out clamping element is bent clear of the plane of the contact element and is then bent off at an angle.

Other advantageous developments and embodiments of the ribbon cable plug-in connector will become apparent from the further dependent claims and from the description that follows.

### DRAWING

FIG. 1 shows a perspective view of a ribbon cable plug-in connector according to the invention;

FIG. 2 shows a detailed illustration according to FIG. 1;

FIG. 3 shows a sectional view of a ribbon cable prepared for contact-making;

FIG. 4 shows a sectional view of a ribbon cable plug-in connector according to the invention, prior to fixing a ribbon cable screening;

FIG. 5 shows a sectional view of a ribbon cable plug-in connector according to the invention, after fixing of a ribbon cable screening; and

FIG. 6 shows a contact element in the form of a punching.

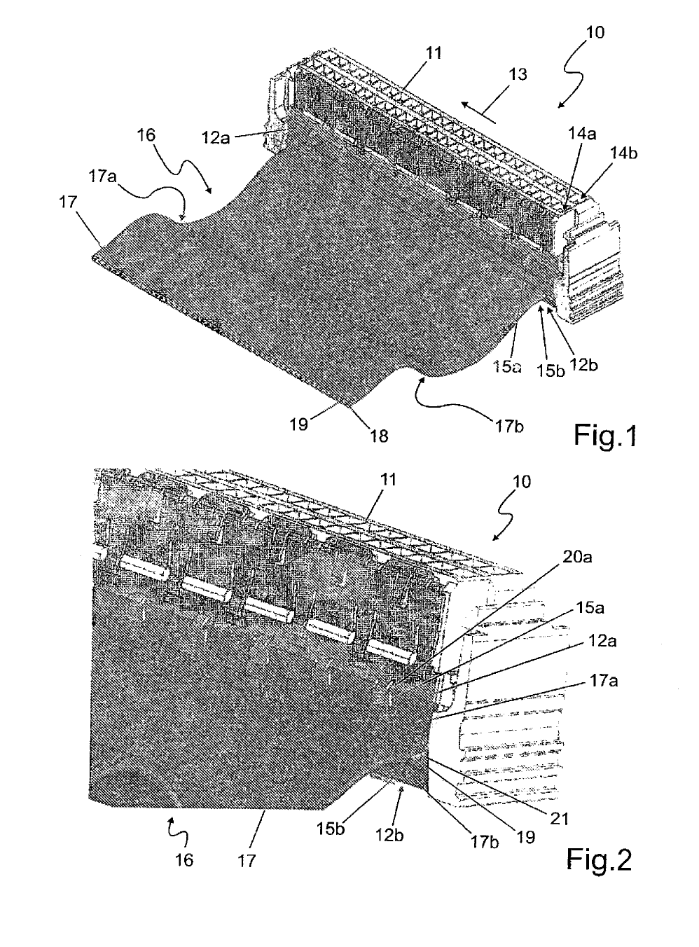

FIG. 1 shows a perspective view of a ribbon cable plug-in connector 10 according to the invention having a plug-in connector element 11 on which a first contact element 12a is arranged that extends in the longitudinal direction 13 of a plurality of plug-in contacts 14a, 15b—not visible in FIG. 1—arranged one beside the other.

At least one first clamping element 15a is provided for fixing an electrically conductive ribbon cable screening 17 that encloses a ribbon cable 16. The ribbon cable screening 17 comprises a first portion 17a on an upper surface of the ribbon cable and a second portion 17b on a lower surface of the ribbon cable.

The ribbon cable screening 17 encloses a plurality of lines 18, each of which is enclosed by a line insulation 19.

The first portion 17a of the ribbon cable screening 17, on the upper surface of the ribbon cable, is contacted by the first contact element 12a and is fixed by the at least one clamping element 15a. The second portion 17b of the ribbon cable screening 17, on the lower surface of the ribbon cable, is contacted by the second contact element 12b, not visible in FIG. 1, and is fixed by at least one clamping element 15b, which likewise is not visible in FIG. 1.

FIG. 2 shows a detail of the ribbon cable plug-in connector 10 illustrated in FIG. 1. In FIG. 2, those parts that conform to the parts illustrated in FIG. 1, are designated by the same reference numerals. FIG. 2 illustrates the way in which the first portion 17a of the ribbon cable screening 17 is contacted by the first contact element 12a and the second portion 17b of the ribbon cable screening 17 is contacted by the second contact element 12b, which is not visible in FIG. 2.

The first portion 17a of the ribbon cable screening 17 is fixed by the at least one first clamping element 15a on the first contact element 17b, while the second portion 17b of the ribbon cable screening 17 is fixed by the at least one second clamping element 15b on the second contact element 12b.

A first recess 20a is provided in the first contact element 12a, in the area of the first clamping element 15a.

The lines 18 enclosed by the line insulations 19 are guided into the plug-in connection element 11 through a ribbon cable bushing 21.

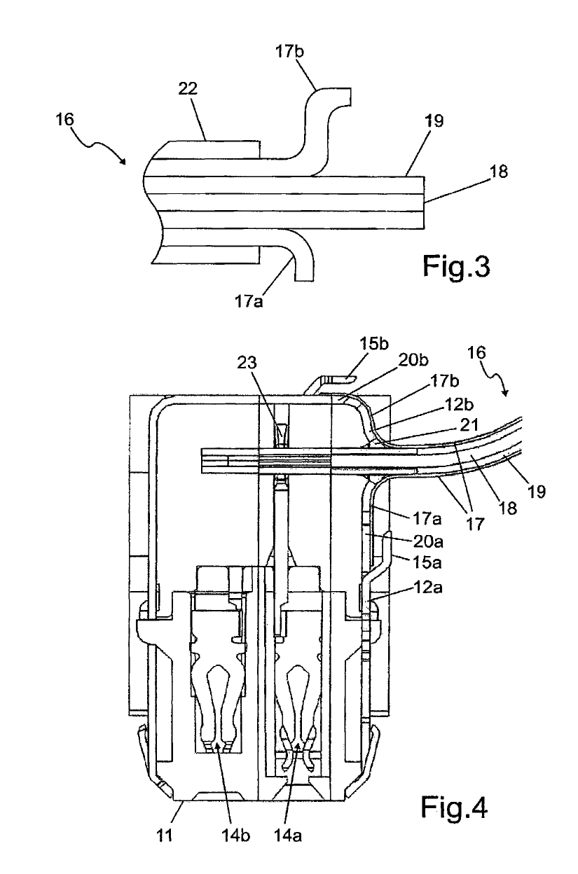

FIG. 3 shows a sectional view of the ribbon cable 16, prepared for being contacted by the first and the second contact elements 12a, 12b. An outer insulation 22, not shown in FIGS. 1 and 2, which surrounds the ribbon cable 16 on its outside, is indicated beside the conductor 18 and its insulation 19 and beside the first and the second portions 17a, 17b of the ribbon cable screening 17.

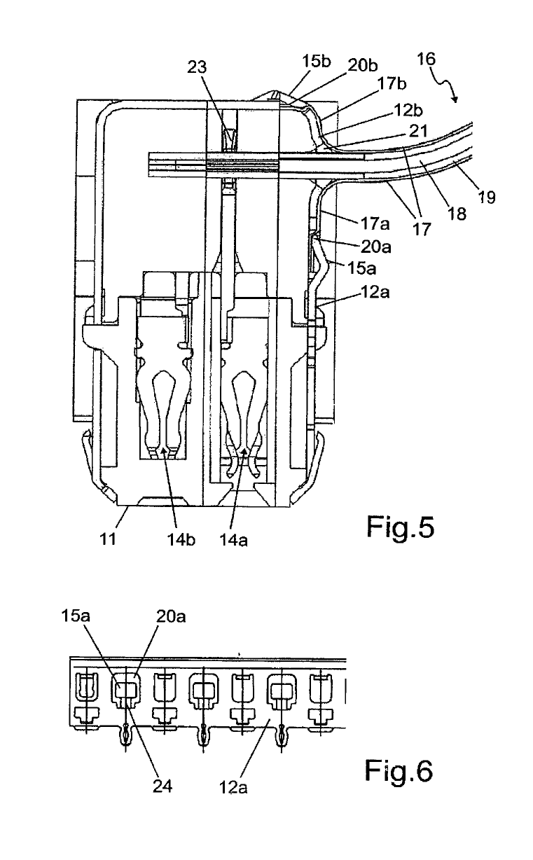

FIGS. 4 and 5 show sectional views of the plug-in connector element 11, along a line passing through the ribbon cable bushing 21. In FIG. 4 and 5, those parts that conform to the parts shown in the previous Figures, are again indicated by the same reference numerals. FIG. 4 shows the way in which the first portion 17a of the ribbon cable screening 17 is contacted by the first contact element 12a and in which the second portion 17b of the ribbon cable screening 17 is contacted by the second contact element 12b, prior to being fixed by the first and the second clamping elements 15a, 15b, respectively, while FIG. 5 shows the situation after fixing.

In FIGS. 4 and 5, a second recess 20b, arranged in the second contact element 12b, is indicated in addition to the first recess 20a. Further, the illustration shows an insulation-piercing contact device 23 of the plug-in connector 14a, intended for establishing contact with the lines 18 of the ribbon cable 16.

FIG. 6 shows the first contact element 15a, formed as a punching. The at least one recess 20a has been punched out, and the part so punched out in part has been bent clear of the plane of the first contact element 15a and has been bent off at an angle so as to form the first clamping element 1Sa. The clamping element 15a comprises a narrower portion 24 between the punched-out clamping element 15a and the contact element 12a.

### DETAILED DESCRIPTION OF THE RIBBON CABLE PLUG-IN CONNECTOR 10

The ribbon cable plug-in connector 10 comprises the plug-in connector element 11, in which a plurality of plug-in contacts 14a, 14b are arranged in the longitudinal direction 13 and by means of which the lines 18 of the ribbon cable 16 are to be contacted. A plurality of the plug-in contacts 14a, 14b are shown in the Figures, arranged one beside the other, although the plug-in contacts 14a, 14b may also be set off—not shown in the drawing—in a direction perpendicular to the longitudinal direction 13. The plug-in contacts 14a, 14b are implemented, for example, as slot contacts, corresponding to pin contacts arranged in the other portion of a corresponding plug-in connector element, not shown in the drawing.

The ribbon cable plug-in connector 10 is intended for connecting electronic components by means of a ribbon cable 16. The ribbon cable 16 comprises a plurality of lines 18, arranged one beside the other, that are enclosed by line insulations 19. The ribbon cable screening 17, which preferably encloses the ribbon cable 16, is provided as a common screening for the lines 18. The ribbon cable screening 17 may be produced, for example, from a wire mesh. The mesh may consist, for example, of a copper braiding which is tin-plated. According to another embodiment, the ribbon cable screening 17 is implemented as a continuous conductive film, for example as a copper film.

The ribbon cable screening 17 acts to attenuate any undesirable radiation of electric signals that are transmitted via the lines 18. Likewise, any undesirable input coupling of external radiation into the lines 18 is diminished. The radiation in question may, for example, be an electromagnetic radiation or a predominantly electric field or a predominantly magnetic field.

As part of the assembly of the ribbon cable plug-in connector 10 to the ribbon cable 16, the ribbon cable screening 17 is lifted off the line insulation 19 and is bent off away from the ribbon cable 16, at least in the area of the ribbon cable bushing 21.

In contrast to the way contact is made with the ribbon cable screening 17 in the prior art, which was accompanied by a considerable deterioration of the screening effect and by considerable assembly effort, the arrangement according to the invention comprises at least one contact element 12a, 12b arranged on the plug-in connector element 11, which extends in the longitudinal direction 13 of the plug-in contacts 14a, 14a and which is intended to make contact with the ribbon cable screening 17, 17a, 17b. Preferably, the contact element 12a, 12b extends over the full width of the ribbon cable 16 and the ribbon cable screening 17, 17a, 17b, respectively.

The ribbon cable plug-in connector 10 according to the invention is easy to assemble and additionally guarantees efficient screening. In addition to the ribbon cable screening 17, the contact element 17a, 17b likewise takes part in screening the plug-in connector 11. The specific configuration of the contact element 12a, 12b, extending in the longitudinal direction 13 of the plug-in connector element 11, leads to low inductance of the arrangement, corresponding to low surge impedance, so that the interfering signals will be diverted to an electric circuit ground with low impedance, up to high frequencies.

Contact is made according to FIG. 3 by cutting each ribbon cable screening 17 laterally and bending up the first and the second portions 17a, 17b on the upper surface of the ribbon cable and the lower surface of the ribbon cable, respectively, for establishing full-surface contact with the contact element 12a, 12b. Any outer insulation 22 present on the ribbon cable 16 is removed before that step.

For establishing the contact, the ribbon cable 16, having been prepared in accordance with FIG. 3, is pushed through the ribbon cable bushing 21 until the at least one portion 17a, 17b of the ribbon cable screening 17 is in surface contact with the at least one contact element 12a, 12b.

According to a simple embodiment, no further measures are needed as the contact between the ribbon cable screening 17, 17a, 17b and the contact element 12a, 12b may already be adequately fixed as a result of the contact established between the lines 18 and the insulation-piercing contact devices 23.

Full screening is achieved, to the extent possible, if the at least one contact element 12a, 12b is arranged adjacent to the ribbon cable bushing 21. In the extreme case, the contact element 12a, 12b may extend almost fully up to the line insulations 19.

It has been assumed so far that at least the first contact element 12a is provided for contact-making with the first portion 17a of the ribbon cable screening 17. Preferably, however, both contact elements 12a, 12b are provided for contact-making with both portions 17a, 17b. In view of the assembly of the contact element 12a, 12b on the plug-in connector element 11, separate contact elements 12a, 12b may be provided. According to one embodiment, not shown in detail, the contact element may of course be a continuous contact element 12a, 12b which fully encloses the ribbon cable 16b or the ribbon cable bushing 21, respectively.

Preferably, at least one clamping element 15a, 15b is provided for fixing the first and/or the second portion 17a, 17b of the ribbon cable screening 17. Advantageously, the at least one first clamping element 15a and the at least one second clamping element 15b, respectively, are provided for both portions 17a, 17b.

The at least one clamping element 15a, 15b may, for example, have a resilient configuration in which case the clamping element 15a, 15b, provided for con-

[symbol]

1. Ribbon cable plug-in connector for connecting electronic components having a plug-in connector element that comprises a plurality of plug-contacts (14a, 14b) characterized in that a contact element (12a, 12b) arranged on the plug-in connector element (11) in the longitudinal direction (13) of the plug-in contacts (14a, 14b) is provided for full-surface contact-making with an electrically conductive ribbon cable screening (17, 17a, 17b) that encloses the ribbon cable (16) on its outside.

2. The ribbon cable plug-in connector as defined in claim 1, characterized in that the contact element (12a, 12b) is arranged at least on both sides of a ribbon cable bushing (21) provided in a plug-in connector element (11) for contacting the portion (17a, 17b) of the ribbon cable screening (17) on the upper surface of the ribbon cable or the lower surface of the ribbon cable, respectively.

3. The ribbon cable plug-in connector as define in claim 1, characterized in that the contact element (12a, 12b) is arranged adjacent to a ribbon cable bushing (21) provided in the plug-in connector element (11).

4. The ribbon cable plug-in connector as defined in claim 1, characterized in that at least one clamping element (15a, 15b) is provided for fixing the ribbon cable screening (17, 17a, 17b).

5. The ribbon cable plug-in connector as defined in claim 4, characterized in that the contact element (12a, 12b) contains the least one clamping element (15a, 15b).

6. The ribbon cable plug-in connector as defined in claim 4, characterized in that the clamping element (15a, 15b) is given a deformable configuration and that, once contact has been established with the ribbon cable screening (17, 17a, 17b) the clamping element (15a, 15b) presses the ribbon cable screening (17, 17a, 17b) against the contact element (12a, 12b).

7. The ribbon cable plug-in connector as defined in claim 4, characterized in that the clamping element (15a, 15b) is given a resilient configuration and that, once contact has been established the clamping element (15a, 15b) presses the ribbon cable screening (17, 17a, 17b) against the contact element (12a, 12b).

8. The ribbon cable plug-in connector as defined in claim 6, characterized in that the contact element (12a, 12b) comprises at least one recess (20a, 20b into which the ribbon cable screening (17, 17a, 17b) is pressed by the clamping element (15a, 15b).

9. The ribbon cable plug-in connector as defined in claim 5, characterized in that the contact element (12a, 12b) is a punching and that the at least one clamping element (15a, 15b) is punched out, is bent clear of the plane of the contact element (12a, 12b) and is bent off at an angle.
